(19) United States
(12) Patent Application Publication
(10) Pub. No.: US 2004/0154429 A1
(43) Pub. Date: Aug. 12, 2004

(54) Two-piece steering wheel back cover

(76) Inventors: Scott L. Rhea, Albion, IN (US); Greg A. Birchmeier, White Lake, MI (US)

Correspondence Address: Sally J. Brown, Autoliv ASP, Inc., 3350 Airport Road, Ogden, UT, 84405, US

(21) Appl. No.: 10/364,741

(22) Filed: Feb. 11, 2003

(51) Int. Cl. B62D 1/06

(52) U.S. Cl. 74/558

(57) ABSTRACT

A steering wheel back cover is disclosed which is composed of multiple interlocking parts. Specifically, the invention provides a two-piece steering wheel back cover which may be securely assembled about a steering column and/or steering wheel of a vehicle. The steering wheel back cover of the invention may be configured to conform to the shape of the steering wheel and to provide an improved view of the control panel of the dashboard to a vehicle operator, and allow attachment of various multi-function switch accessories.

### BACKGROUND OF THE INVENTION

1. Field of the Invention

The present invention relates to steering wheel components for automobiles, trucks, and industrial equipment. More specifically, the present invention relates to covers adapted to enclose portions of the steering wheel assembly such as portions of the steering wheel and steering column.

2. Description of Related Art

Steering wheel back covers are commonly used in vehicles to act as an aesthetic and protective cover for the inner workings of the steering wheel and its interface with the steering column. In modern vehicles, steering wheel covers also serve to protect the delicate electronics attached to controls positioned in the steering wheel or placed in control levers extending from the steering column. As a result, steering wheel back covers are generally substantially rigid in structure. In addition, these covers are generally monolithic in order to maintain reasonable material and manuf acturing expenses.

The design of these steering wheel back covers has been dramatically affected in recent years by automotive design trends that include the addition of multi-function switches being mounted to the steering wheel. In addition, safety studies have influenced the positioning of the operator in a vehicle, and thus have revised the placement of vehicle controls. One difficulty encountered in relation to many vehicle designs is the obscuring of critical dashboard-positioned controls such as the speedometer and fuel gauge, among others, by the steering wheel and by the steering wheel back cover. Specifically, it has been noted that in some applications, traditional steering wheel back cover designs extend upwardly from the steering wheel into the vehicle operator's potential field of view of the controls.

In response to these difficulties, new one-piece back cover designs have been proposed to improve control panel visibility. These designs often utilize angled or flattened designs to avoid intrusion into the occupant's field of view. In many situations, however, these designs have proven expensive or impractical to produce because their design is incompatible with the manufacturing methods traditionally used in their production, and because alternative production methods have proven impractical.

Steering wheel back covers have generally been produced using molding techniques such as injection-molding. These techniques generally allow for cost-effective mass production of the back covers and assure uniformity of the final product.

Although injection-molding technology is capable of producing a wide variety of items having a variety of shapes, each must be adapted with the limitations of the manufacturing technology in mind. Specifically, in this and other molding technologies, every structure being molded must have surfaces angled inwardly in relation to the surface of the mold. This angle is called a “draft angle,” and is included to allow the final molded structure to be removed from the mold. This angle is a necessary since many commonly-used molding materials contract after molding. This renders them difficult to remove from the mold, thus increasing production difficulty, and often, mold-maintenance costs. With most articles to be molded, the introduction of a slight angle alleviates this problem without drastically affecting the design of the final product.

In some situations, however, the introduction of even a slight draft angle is unacceptable for the finished part. Inability to provide draft in such parts greatly hampers their production, increasing their cost. This was the case with many proposed designs for monolithic steering wheel back covers designed to improve control panel visibility. As a result, it would be an improvement in the art to provide a steering wheel back cover designed to improve control panel visibility which may be produced using conventional methods, even when no draft angle may be permitted in the final product.

In addition to the above, molded parts often exhibit “parting lines”-surface features such as ridges which correspond to the joint between opposing halves of the product mold. These ridges may be visible to the user of the part or to the consumer of the finished product including the part. In some cases, these visible lines are cosmetically unacceptable, and less commonly, the ridges may even interfere with the function of the part. Hence it would be an improvement in the art to provide a steering wheel back cover designed to improve control panel visibility which may be produced without obtrusive parting lines.

Steering wheel back covers have traditionally been made in one piece. In some applications, this has served to limit the possible shapes and sizes of usable back covers, and has also limited the installation options for such back covers. It would be desirable to provide a steering wheel back cover which could be composed of multiple parts which securely interlock about an existing steering wheel and/or steering column. This could also allow assembly of the back cover without the need to disassemble the steering wheel and steering column. It would also be an advancement to provide a steering wheel back cover that could attach to the steering wheel without additional connectors or fasteners.

Finally, as a result of manufacturing difficulties such as those explained above, it has proven difficult to construct steering wheel back covers which match the shape and contour of the shrouds used to cover the steering column of a vehicle. It would be an advancement in the art to provide steering wheel back covers that could be varied dramatically in shape in order to match them carefully to the steering column shrouds and with interior trim panels of the vehicle, and allow the attachment of various multi-function switches and accessories.

Accordingly, a need exists for a steering wheel back cover that may be manufactured using traditional methods for use in no-draft conditions. In addition, a need exists for a steering wheel back cover in which parting lines may be placed to minimize their visibility and prevent interference with the function of the back cover. Finally, it is desirable to provide such a back cover that may be constructed in a wide variety of configurations in order to provide design flexibility to allow enhancement of control panel visibility and the attachment of accessory features to a steering wheel.

Such a steering wheel back cover is disclosed herein.

### SUMMARY OF THE INVENTION

The apparatus of the present invention has been developed in response to the present state of the art, and in particular, in response to the problems and needs in the art that have not yet been fully solved by currently available steering wheel back covers. Thus, the present invention provides a steering wheel back cover having multiple components which may be manufactured using traditional methods for use in conditions where a draft angle is unacceptable.

In accordance with the invention as embodied and broadly described herein in the preferred embodiment, a steering wheel back cover is provided. The steering wheel back cover is made up of multiple interlocking parts to allow greater flexibility in the design of the steering wheel back cover, and to simplify the manufacturing of steering wheel back cover designs which otherwise would be difficult and potentially costly to build due to their design.

The steering wheel back covers of the invention may be adapted to enclose a portion of the steering wheel assembly, including part of the steering wheel and often a region of the steering column. The covers of the invention are built using a generally rigid material such as plastic or a composite material. The steering wheel back cover of the invention has multiple interlocking parts that assemble to form a housing with sidewalls and a base to securely enclose the components of the steering wheel assembly.

The sidewalls are composed of a plurality of sidewall panels adapted to conform to the shape of the steering wheel assembly to which the housing is to be attached. Additionally, the sidewalls may be shaped to maximize the ability of the driver of a vehicle having the steering wheel back cover to see the control panel. Further, the sidewall panels may be constructed to match the shape and contours of the steering column shroud. Additionally, openings may be formed in the sidewalls, including openings at the seams of the sidewall panels to permit the use of the steering wheel back cover with steering wheel designs that include controls which protrude from the rear or sides of the steering wheel assembly.

The sidewall panels of the back cover of the invention may further define a base. This base may be constructed to conform to the shape and size of the steering column of the vehicle in which it will be installed. As such, the base may include an orifice to permit the installation of the back cover about the steering column and contours to conform the back cover to the steering column shroud design.

The steering wheel back cover is preferably composed of at least two sidewall panels. The sidewall panels are constructed to be securely joined together at a pair of side joints by a locking mechanism. The side joints of the back cover may be configured to include openings to permit the protrusion of controls or accessories from the steering wheel or column as discussed briefly above. Additionally, the side joints may include features such as gap seals to prevent the passage of materials into the housing and protect the steering wheel assembly, as well as to block any passage of light through the joints of the housing.

The locking mechanism of the sidewall panels of the steering wheel back cover preferably includes a biased latch. Such latches are preferred for their ability to securely hold the panels together while allowing snap-together assembly, thus requiring no additional fasteners. In some embodiments, the biased latch has a biased tab attached to one of the panels making up the sidewall, and a locking groove formed in the other sidewall panel. Such sidewall panels generally have at least one such tab or groove located at each side joint. To assemble the back cover of the invention, the sidewall panels are aligned, brought into contact with each other, and pressure is applied to them. This pressure deforms the biased tabs, which displace to allow the panels to slide together. When the panels are brought into their intended configuration, the biased tabs snap into place in the locking grooves positioned in the opposing sidewall panel, locking the panels together about the steering wheel assembly.

To ease assembly of the steering wheel back cover of the invention, the locking mechanism may additionally include an alignment assembly to bring the sidewall panels into alignment with each other. In the locking mechanism just described, the alignment assembly may take the form of a fixed loop attached to one sidewall panel and a hook attached to the opposing sidewall panel at each potential side joint. In use, the hook is placed through the fixed loop. This aligns the sidewall panels at an angle to their final placement. Following this, the panels may be rotated toward each other about an axis defined by the alignment assembly. This allows the components of the locking mechanism to be brought into contact for assembly.

In alternate embodiments of the invention, the locking assembly of the steering wheel back cover has a biased latch which may use a plurality of locking tabs positioned on either or both of the sidewall panels such that they interlock with a feature of the other sidewall panel. More specifically, the latch uses at least one locking tab at each side joint that extends over the joint and contacts at least one feature or region of the other sidewall panel. In some embodiments, this feature or region is a locking ridge which the locking tab snaps into place over. In some embodiments of the back cover of the invention, it is preferred that the biased latch includes at least one locking tab extending over the joint from each sidewall panel, thus having two opposing locking tabs at each side joint. In alternate embodiments of the invention, a plurality of locking tabs extends from at least one of the sidewall panels over each side joint and interlocks with a feature of the other sidewall panel.

These and other features and advantages of the present invention will become more fully apparent from the following description, drawings, and appended claims, or may be learned by the practice of the invention as set forth hereinafter.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of a steering wheel back cover of the invention shown from the rear assembled about a steering column and mounted to a steering wheel assembly;

FIG. 2 is an isolated perspective view of the steering wheel back cover shown in FIG. 1;

FIG. 3A is a detailed view of a panel locking assembly and a panel alignment assembly of the steering wheel back cover of FIG. 2;

FIG. 3B is a perspective view of a portion of the steering wheel back cover of the invention having a steering wheel armature prior to its assembly about a steering wheel;

FIG. 3C is a perspective view of a portion of the steering wheel back cover of the invention having a steering wheel armature after its assembly about a steering wheel;

FIG. 3D is a cross-sectional view of the portion of the steering wheel back cover of the invention shown in FIG. 3C; and

FIG. 4 is an isolated perspective view of an alternative embodiment of the steering wheel back cover of the invention.

### DETAILED DESCRIPTION OF THE PREFERRED EMBODIMENTS

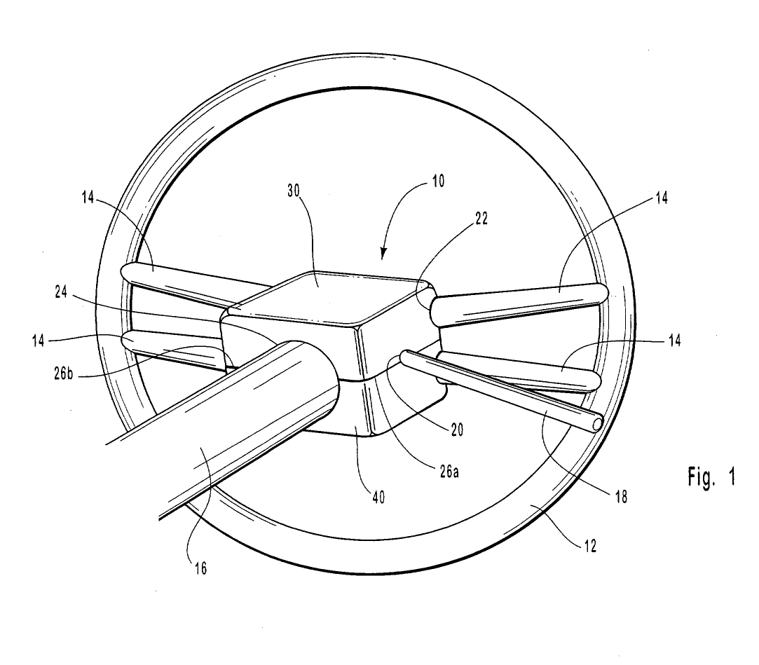

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus of the present invention, as represented in FIGS. 1 through 4, is not intended to limit the scope of the invention, as claimed, but is merely representative of presently preferred embodiments of the invention.

The present invention provides a multipart back cover for a steering wheel assembly that allows greater freedom in the design of steering wheel back covers while remaining susceptible to manufacture using existing molding technologies. The use of multiple interlocking components allows greater flexibility in cover design, including contexts requiring no draft on a least a portion of the final part, while remaining within the limits of known molding technologies. This allows the use of designs which could previously not be practically mass-produced.

In this application, the phrases “connected to,” “coupled to,” and “in communication with” refer to any form of interaction between two or more entities, including mechanical, electrical, magnetic, electromagnetic, and thermal interaction. The phrase “attached to” refers to a form of mechanical coupling that restricts relative translation or rotation between the referenced objects. The phrases “pivotally attached to” and “slidably attached to” refer to forms of mechanical coupling that permit relative rotation or relative translation, respectively, while restricting other relative motion. Further, the term “attached directly to” refers to a form of attachment by which the referenced objects are either in direct contact, or are only separated by a single fastener, adhesive, or attachment mechanism. The term “abutting” refers to items that are in direct physical contact with each other, but which may not be attached together.

Referring first to FIG. 1, a steering wheel 12 and a steering column 16 are shown in a rear perspective view housed by an exemplary embodiment of the steering wheel back cover 10 of the invention. The back cover 10 is shown to include an upper housing panel 30 and a lower housing panel 40 attached about the steering column 16. These upper and lower panels 30, 40 unite at side joints 26a, 26b. The upper and lower panels 30, 40 may include be configured to unite to form orifices such as a steering column passage 24 to permit the back cover 10 to be installed about the steering column 16.

Additionally, the upper and lower panels 30, 40 may join to form additional orifices such as an accessory opening 20 through which an accessory control 18 positioned near the steering wheel 12 protrudes for access by a vehicle operator (not shown). Such accessory controls may include gear shift levers, headlight/turn signal levers, windshield wiper levers, speed controls, radio controls, a message center, or other controls which may be conveniently placed near a steering wheel 12 for easy access by a vehicle operator. Still further, each of the upper and lower sidewall panels 30, 40 may be configured to include spoke notches 22 to allow tighter abutment of the back cover 10 with the steering wheel 12, and specifically with the spokes 14 of the steering wheel 12.

In FIG. 1, the sidewall panels 30, 40 of the back cover 10 are shown to be substantially rectangular in shape with rounded corners and edges. Those of skill in the art will recognize that these structures may have a wide variety of shapes within the scope of the invention. Specifically, the sidewall panels 30, 40 may be constructed to form a round or ovoid cylindrical structure, or may be more significantly flattened to avoid intrusion of the cover 10 into the vehicle operator's field of view. Additionally, although in these exemplary embodiments, the sidewall panels 30, 40, are designated “upper” and “lower,” one of skill in the art will recognize that the structures of the panels 30, 40 may be adapted to be attached about a steering wheel assembly in a large number of orientations, including the exemplary “upper” and “lower” configuration shown.

In this embodiment of the invention, the back cover 10 is composed of two sidewall panels 30, 40, which may be molded separately. This may be advantageous in situations in which the design of the back cover 10 will not tolerate the introduction of a draft angle to the faces of the cover 10 during manufacturing. Similarly, the position of mold segment parting lines produced during manufacturing may be controlled to reduce the impact of such parting lines on the final form and function of the steering wheel back cover 10.

In addition, this embodiment of the back cover 10 may be configured to be attached directly to the steering wheel 12. In some cases, the back cover 10 may be adapted to be attached directly to the steering wheel 12 and attached slidably about the steering column 16 without the need for additional connectors, thus producing a potential cost and weight savings.

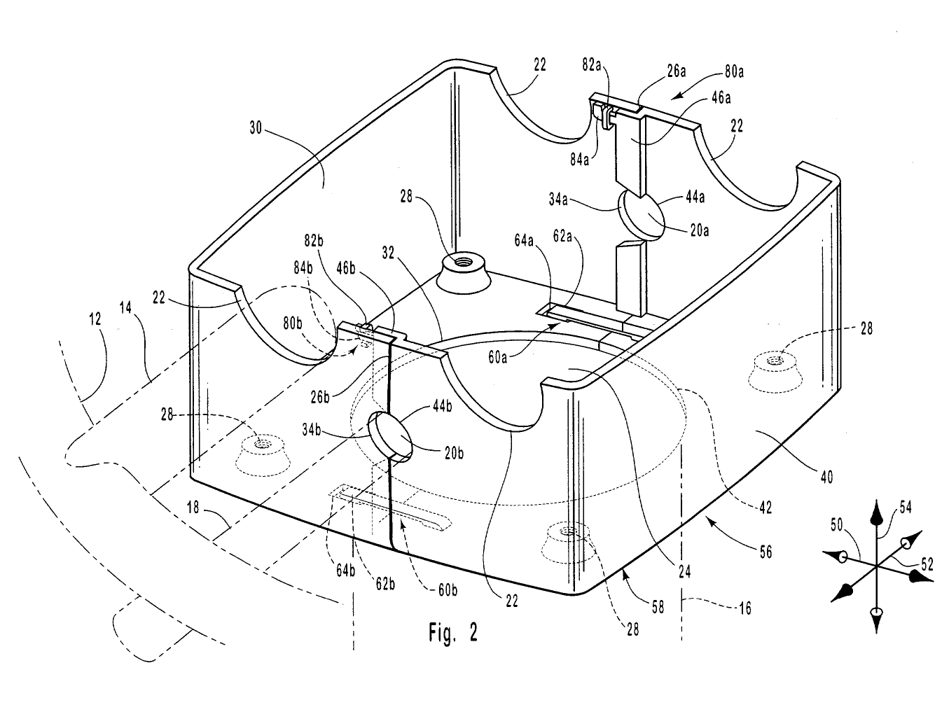

Referring now to FIG. 2, an isolated perspective view of the steering wheel back cover 10 of the invention is shown with the steering wheel 12 partially illustrated in phantom. The steering wheel back cover 10 has a longitudinal direction 50, a lateral direction 52, and a transverse direction 54. As illustrated in FIG. 1 above, the steering wheel back cover 10 is shown to comprise an upper housing panel 30 and a lower housing panel 40 securely linked to form the cover 10.

As above, the upper housing panel 30 is shown attached to the lower housing panel 40. These panels 30, 40 unite to form sidewalls 56 and base 58 at side joints 26a, 26b. Side joints 26a, 26b are here shown to include a gap cover 46a, 46b used to prevent introduction of matter into the back cover 10 and to prevent passage of light through the side joints 26a, 26b of the back cover 10. These gap covers 46a, 46b, as shown, may simply be extensions of the lower housing panel 40, or alternatively of the upper housing panel 30. In FIG. 2, the side joints 26a, 26b are shown to define accessory openings 20a, 20b formed of the pairing of accessory notches 34a, 34b formed in the upper housing panel 30 with accessory notches 44a, 44b, of the lower housing panel 40, and by the configuration of the associated gap covers 46a, 46b of the side joints 26a, 26b. As shown in phantom and briefly discussed above, such accessory openings 20 permit the penetration of control levers 18 (shown in phantom) such as gear shift levers, headlight/turn signal levers, windshield wiper levers, speed controls, radio controls, a message center, or other controls through the back cover 10 for access by the vehicle operator (not shown).

FIG. 2 further portrays the components and configuration of the panel locking assemblies 60a, 60b of this embodiment of the steering wheel back cover 10 of the invention. In this embodiment, each locking assembly 60a, 60b includes a biased tab 62a, 62b passing from the lower housing panel 40 over the upper housing panel 30 into a locking groove 64a, 64b configured to hold the biased tab 62a, 62b. During assembly, each biased tab 62a, 62b of the lower housing panel 40 passes over the upper housing panel 30 and is displaced from its original transverse position. When each biased tab 62 encounters a corresponding locking groove 64a, 64b, it returns at least partially to its original transverse position to hold the upper and lower housing panels 30, 40 securely in place.

In FIG. 2, the biased tabs 62a, 62b and the locking grooves 64a, 64b of the panel locking assemblies 60a, 60b are positioned on the base 58 of the back cover 10. One of skill in the art readily understand that these components of the locking assemblies 60a, 60b may be relocated to other surfaces such as the sidewalls 56 of the back cover 10, reoriented such that the biased tabs 62a, 62b are positioned on the upper housing panel 30 and the locking grooves 64a, 64b on the lower housing panel 40, or multiplied in number to increase the strength of the joints 26a, 26b of the back cover 10.

In addition to the panel locking assemblies 60a, 60b, the back cover 10 includes panel alignment assemblies 80a, 80b to assist in the assembly of the back cover 10. In this embodiment of the back cover 10, the panel alignment assemblies 80a, 80b, each have either a fixed loop 82a, 82b or a swing hook 84a, 84b. In this example, a fixed loop 82a, 82b is shown positioned on a side of the upper housing panel 30 facing the side joints 26a, 26b, and each swing hook 84a, 84b is shown positioned on both sides of the lower housing panel 40 facing the side joints 26a, 26b. One of skill in the art would understand that the positions of the swing hooks 84a, 84b and the fixed loops 82a, 82b may be varied within the scope of the invention.

As additionally shown in FIG. 2, the back cover 10 of the invention may include additional elements to allow it to be more closely or securely attached to a steering wheel 12. Specifically, the sidewalls 56 of the back cover 10 are shown to include spoke notches 22 to allow the back cover 10 to more closely abut the steering wheel 12 when the back cover 10 is installed. One of skill in the art would understand that the number and size of the spoke notches 22 and the steering wheel mounts 28 may be varied to better complement the shape and size of the steering wheel 12. The steering wheel back cover 10 of FIGS. 1 and 2 is shown to be configured for use with a steering wheel 12 having four spokes 14 and four attachment points (not shown). Additionally, the back cover 10 is shown to include steering wheel mounts 28 for use with bolts or other such coupling devices (not shown) in attaching the back cover 10 to the steering wheel 12.

During assembly of the back cover 10, the panels may be attached to each other using the panel alignment assemblies 80a, 80b and the panel locking assemblies 60a, 60b. First, the panels 30, 40 are brought near to each other. The swing hooks 84a, 84b of the panel alignment assemblies 80a, 80b are then inserted within the fixed loops 82a, 82b of the upper housing panel 30. The upper housing panel 30 is then raised in a transverse direction until the swing hooks 84a, 84b are slidably attached to the fixed loop 82a, 82b. This allows the lower housing panel 40 to rotate about an axis 70 that may be defined by the alignment assemblies 80a, 80b with respect to the upper housing panel 30. Such rotation allows the biased tabs 62a, 62b of the locking assemblies 60a, 60b to be brought into alignment for attachment.

The lower housing panel 40 may next be rotated downwardly in a transverse direction 54 until the biased tabs 62a, 62b are abutting the upper housing panel 30. Pressure is next placed on the opposing upper and lower housing panels 30, 40 inwardly along opposing longitudinal directions. This pressure results in deformation of the biased tabs 62a, 62b, displacing them from their original transverse position sufficiently to allow them to slide over the inside surfaces of the base 58 of the upper housing panel 30. The upper and lower housing panels 30, 40 travel toward each other until they abut, at which point the biased tabs 62a, 62b snap into place in their respective locking grooves 64a, 64b positioned in the upper housing panel 30. One of skill in the art would recognize that the components of the alignment assembly may be varied to use other mechanisms to allow pivoting about an axis such as 70 to align the panels 30, 40 of the steering wheel back cover 10.

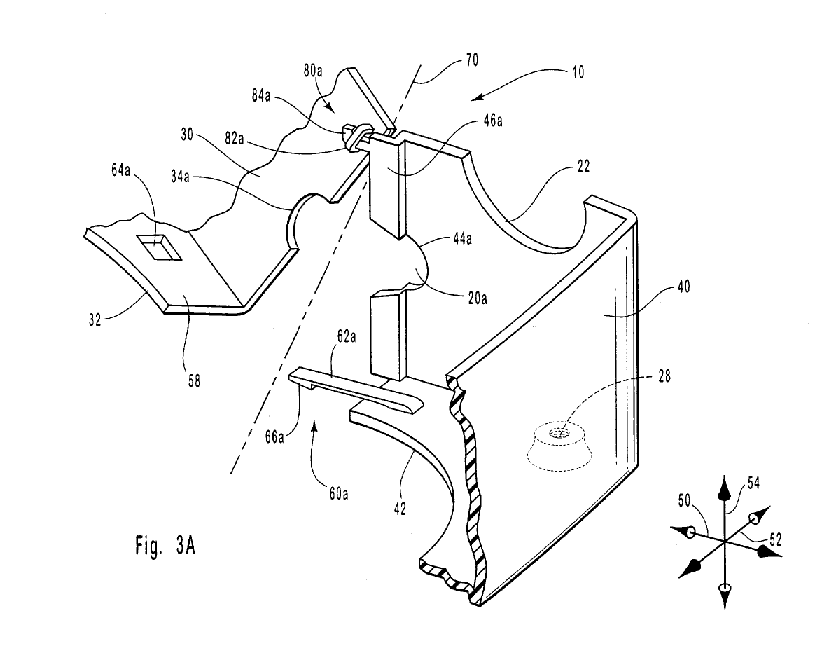

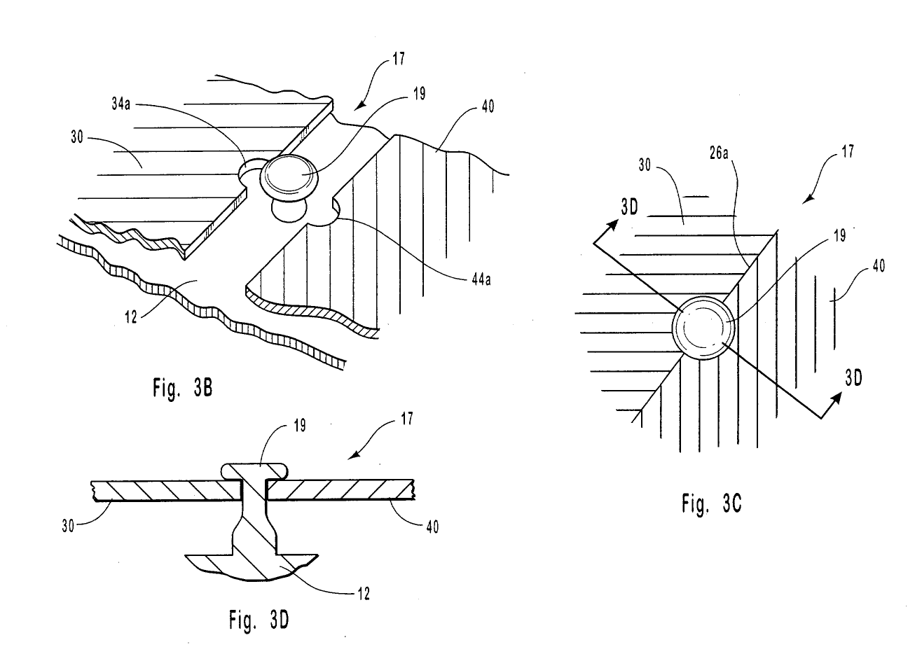

Referring now to FIG. 3A, a more detailed view of a portion of the steering wheel back cover 10 of the invention is shown. More specifically, the panel locking assembly 60a and the panel alignment assembly 80a of the steering wheel back cover 10 of FIGS. 1 and 2 are shown in detail with the upper and lower housing panels 30 and 40 shown slightly separated. As described above, in this configuration, the upper and lower housing panels 30, 40 are rotatably attached about an axis 70 defined by the fixed loop 82 engaged by the swing hook 84. As the upper and lower housing panels 30, 40 are brought together, the tip 66 of the biased tab 62 is displaced in a substantially transverse direction 54 to permit it to slide along an inside surface of the base 58 of the back cover 10. The tip 66 of the biased tab 62 then encounters the locking groove 64, into which it penetrates, substantially returning to its original transverse position.

In some embodiments of the invention, the locking groove 64 is simply an indentation into the inside surface of the base 58 of the back cover 10. In alternative embodiments, however, the locking groove 64 may include a complete penetration of the base 58. In such embodiments, when the tip 66 of the biased tab 62 is locked into position in the locking groove 64, it is accessible from the outside face of the back cover 10. This allows for the application of force to the tip 66 of the biased tab 62 in a transverse direction to release the tip 66 from the locking groove 64, thus allowing the upper and lower housing panels 30, 40 to be separated when needed. Such a configuration may be desirable in applications in which it is anticipated that the steering wheel back cover 10 will need to be repeatedly removed and replaced, as in applications in which frequent access will be needed to the steering wheel 12 or its components.

The panel alignment assembly 80a shown in FIG. 3A uses swing hook 84a and fixed loop 82a to align the panels 30, 40 to facilitate the assembly of the back cover 10. The fixed loop 82a, shown mounted to sidewall panel 30, is configured to be engaged by the swing hook 84a, projecting from gap cover 46a. After engagement of these components 82a, 84a, on each end of the sidewall panels 30, 40, near future side joints 26a, 26b, the panels 30, 40 may be rotated about an axis 70 defined by the alignment assembly 80a. One of skill in the art would recognize that the configuration of the alignment assemblies of the invention 80a, 80b (shown in FIG. 2) may be varied to provide an axis of rotation that aligns the components of the locking assemblies 60a, 60b (shown in FIG. 2). Acceptable configurations include the swing hook 84a and the fixed loop 82a, which may alternatively be located on the bottom of the back cover 10 with a panel locking assembly 60a positioned on the sidewalls 30, 40. This configuration would provide an alternate swing rotation to align and attach the sidewall panels 30, 40.

FIG. 3B shows a still further isolated view of a portion of the steering wheel back cover 10 of FIG. 3A. Specifically, FIG. 3B shows portions of the sidewall panels 30, 40 in position for assembly. The sidewall panels 30, 40, are shown to include accessory notches 34a, 44a, respectively. In FIG. 3B, the accessory notches 34a, 44a, are configured to unite about a steering wheel armature assembly 17, here comprising an attachment stem 19. The attachment stem 19 may be a component of the steering wheel or of the steering column (not shown). The steering wheel armature assembly 17 enables the steering wheel back cover of the invention to be attached to a steering wheel or steering column (not shown) without the use of additional procedures or connectors. Alternatively, the attachment stem 19 is representative of a base or portion of an accessory lever such as a multi-function switch (not shown), about which the sidewall panels 30, 40 may be similarly attached.

FIG. 3C shows the sidewalls 30, 40 of the steering wheel back cover of the invention assembled about the attachment stem 19 of the steering wheel armature assembly 17. As above, the sidewalls 30, 40 join to form a joint 26a. In this case, the joint 26a travels about the outer surface of the attachment stem 19. The attachment stem thus operates to secure the steering wheel back cover to the steering wheel (not shown). FIG. 3D further shows this relationship, illustrating a cross-sectional view of the sidewall panels 30, 40 uniting about the attachment stem 19. In this view, the attachment stem 19 is shown to be an elongated stalk stemming from the steering wheel 12. The attachment of the sidewall panels 30, 40 about the attachment stem 19 allows the steering wheel back cover to be secured to the steering wheel 12 without the need for any additional connectors or procedures, thus potentially reducing the cost of the use of steering wheel back covers. One of skill in the art would understand that the position, shape, and configuration of the attachment stem 19 may be varied within the scope of the invention.

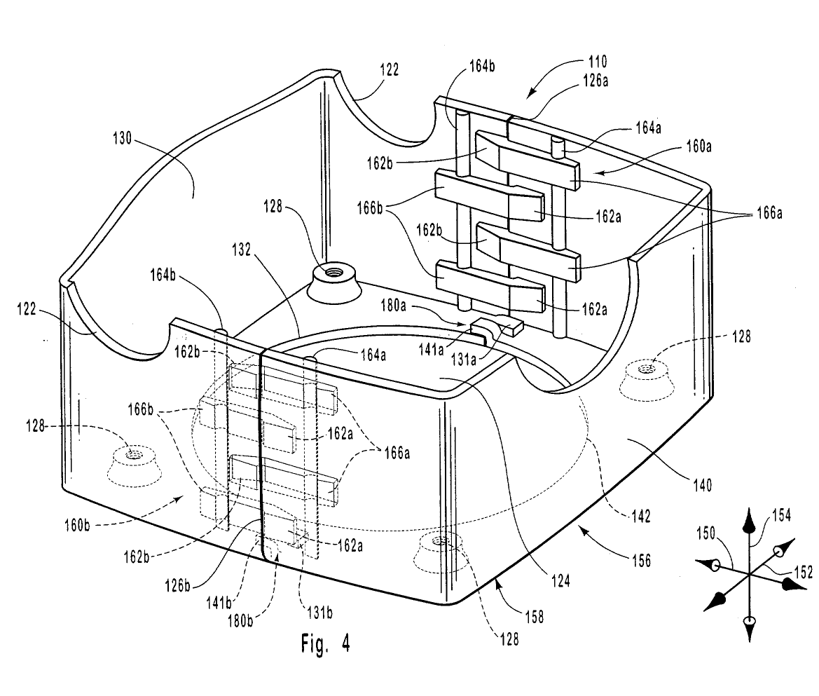

Referring now to FIG. 4, an isolated perspective view of an alternative embodiment of the steering wheel back cover 110 of the invention is shown. The steering wheel back cover 110 has a longitudinal direction 150, a lateral direction 152, and a transverse direction 154. As in the embodiment of FIGS. 1-3 above, the steering wheel back cover 110 includes upper and lower housing panels 130, 140, respectively.

In this embodiment of the steering wheel back cover 110 of the invention, as above, upper and lower housing panels 130 and 140 unite at side joints 126a, 126b to form sidewalls 156 and a base 158. As above, the upper and lower housing panels 130, 140 are configured for attachment to a steering wheel (not shown) and a steering column (not shown). Specifically, the upper and lower housing panels 130, 140 include steering column notches 132, 142, respectively, which unite when assembled to form a steering column passage 124. Further, the upper and lower housing panels 130, 140 could alternatively be configured as in the embodiment of FIGS. 1-3 above to define accessory openings and attachment features. In addition, the housing panels 130, 140 include a number of spoke notches 122 designed to accommodate the spokes of the steering wheel (not shown). The back cover 110 is shown having 3 notches 122. As configured, the back cover 110 may thus be assembled about a steering wheel and steering column assembly (not shown). The upper and lower housing panels 130, 140 are configured to be tightly attached to each other during assembly by panel locking assemblies 160a, 160b.

Each of the panel locking assemblies 160a, 160b of the invention includes at least one biased tab 162a, 162b extending from each of the housing panels 130, 140. As understood by one of skill in the art, the number, shape, latch design, latch style and placement of these biased tabs 166a, 166b may be widely varied based on the size and strength requirements of the back cover 110 and on the size and configuration of the steering wheel to which the back cover 110 is to be attached. The biased tabs 166a, 166b are configured to pass over the inside surface of the sidewalls 156 or base 158 of the back cover 110 and engage a raised feature of the back cover 110 such as locking ridges 164a, 164b.

During assembly, the upper and lower housing panels 130, 140 are first brought into abutment with each other. Following this, pressure is applied to the panels 130, 140 in a lateral direction 152 to push the panels 130, 140 together. As the pressure is applied, the biased tabs 162a, 162b on their respective panels 130, 140 travel along the inside surface of the sidewalls 156 until their tips 166a, 166b contact the locking ridges 164a, 164b. In order to secure the tips 166a, 166b of the biased tabs 162a, 162b over the locking ridges 164a, 164b, additional pressure is applied, following which the biased tabs 162a, 162b engage the locking ridges 164a, 164b.

One of skill in the art would understand that the number of biased tabs 162a, 162b, as well as the dimensions of the locking ridges 164a, 164b, and the configuration of the tips 166a, 166b of the tabs 162a, 162b, may be varied within the scope of the invention in order to regulate the strength of the attachment of the upper and lower housing panels 130, 140, and the amount of pressure needed to assemble the steering wheel back cover 110 of the invention.

The sidewall panels 130, 140 may further include a panel alignment mechanism 180a, 180b to properly align the panels 130, 140. This panel alignment mechanism may be similar to the panel alignment assembly 80a, 80b of FIGS. 2-3C. In FIG. 4, the alignment mechanism 180a, 180b included is paired interlocking arms 131a, 131b and 141a, 141b. Specifically, as shown, sidewall panel 130 is shown to include interlocking arms 131a, 131b which extend over the seam 126a, 126b. Similarly, sidewall panel 140 is shown to include interlocking arms 141a, 141b which extend over the seam 126a, 126b. When the panels 130, 140 are locked together, the interlocking arms 131a, 131b, 141a, 141b align and stabilize the sidewall panels 130, 140 in position by preventing relative motion along an axis such as the lateral axis 152.

As additionally shown in FIG. 4, the back cover 110 of the invention may include additional elements to allow it to be more closely or securely attached to a steering wheel (not shown). Specifically, the sidewalls 156 of the back cover 110 are shown to include spoke notches 122 to allow the back cover 110 to more closely abut a steering wheel when the back cover 110 is installed. Additionally, the back cover 110 is shown to include steering wheel mounts 128 for use with bolts or other such coupling devices (not shown) in attaching the back cover 110 to a steering wheel. One of skill in the art would understand that the number and size of the spoke notches 122 and the steering wheel mounts 128 may be varied to better complement the shape and size of the steering wheel. The steering wheel back cover 110 of FIG. 4 is shown to be configured for use with a steering wheel having three spokes and four attachment points (not shown).

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed and desired to be secured by United States Letters Patent is:

1. A steering wheel back cover comprising:
a housing having sidewalls and a base, the housing being formed of a first sidewall panel and a second sidewall panel configured to be securely attached to each other at first and second side joints; and
a locking mechanism for securing the first and second sidewall panels to each other, wherein the housing is adapted to enclose a portion of a steering wheel assembly and a steering column of a vehicle.

2. The steering wheel back cover of claim 1, wherein the locking mechanism comprises a biased latch including a biased tab affixed to a first sidewall panel and a locking groove formed in a second sidewall panel for receiving the biased tab.

3. The steering wheel back cover of claim 2, wherein the locking groove does not completely perforate the second sidewall panel.

4. The steering wheel back cover of claim 2, wherein the locking mechanism is positioned on the base of the housing.

5. The steering wheel back cover of claim 4, wherein the locking mechanism further comprises an alignment mechanism for aligning the first and second sidewall panels prior to attachment.

6. The steering wheel back cover of claim 5, wherein the alignment mechanism comprises a fixed loop attached to a first sidewall panel and a hook attached to a second sidewall panel, wherein the hook is configured to pivot about the fixed loop to align the first and second sidewall panels for attachment.

7. The steering wheel back cover of claim 5, wherein the alignment mechanism comprises a first arm attached to the first sidewall panel and a second arm attached to the second sidewall panel, wherein the first and second arms interlock to align and stabilize the first and second sidewall panels.

8. The steering wheel back cover of claim 1, wherein the locking mechanism comprises a plurality of biased locking fingers and a locking ridge positioned on each sidewall panel such that when aligned for attachment, the teeth on each sidewall panel engage the locking ridge.

9. The steering wheel back cover of claim 1, wherein the housing further comprises a steering wheel mount for securely attaching the housing to a steering wheel.

10. The steering wheel back cover of claim 1, wherein the first and second side joints further comprise gap covers.

11. The steering wheel back cover of claim 1, wherein the first and second side joints comprise accessory openings.

12. The steering wheel back cover of claim 1, wherein the housing further comprises spoke notches.

13. A steering wheel back cover comprising:
an upper housing panel;
a lower housing panel, wherein the upper and lower housing panels may be attached at first and second side joints to form a steering wheel back cover;
a panel locking assembly for securely attaching the upper and lower housing panels; and
an alignment mechanism for aligning the upper and lower housing panels for attachment; wherein the housing is adapted to enclose a portion of a steering wheel assembly of a vehicle.

14. The steering wheel back cover of claim 13, wherein the panel locking assembly comprises a spring latch having a biased tab positioned on one of the housing panels and a locking groove positioned on the other housing panel.

15. The steering wheel back cover of claim 13, wherein the panel alignment mechanism comprises an alignment loop attached to one of the housing panels and a swing hook attached to the other housing panel.

16. The steering wheel back cover of claim 13, wherein the panel alignment mechanism comprises a first arm attached to the upper housing panel and a second arm attached to the lower housing panel, wherein the first and second arms interlock to align and stabilize the upper and lower sidewall panels.

17. The steering wheel back cover of claim 13, wherein the upper and lower housing panels combine to further define a mounting base.

18. The steering wheel back cover of claim 17, wherein the mounting base is an annular surface positioned at an angle to the sidewall panels.

19. The steering wheel back cover of claim 18, wherein the mounting base is substantially perpendicular to the sidewall panels.

20. The steering wheel back cover of claim 17, wherein the panel locking assembly comprises a spring latch having a biased tab positioned on one of the housing panels and a locking groove positioned on the other housing panel.

21. The steering wheel back cover of claim 20, wherein the biased tab is positioned on a portion of the mounting base defined by one of the housing panels, and wherein the locking groove is positioned on a portion of the mounting base defined by the other housing panel.

22. The steering wheel back cover of claim 21, wherein the panel alignment mechanism comprises an alignment loop attached to one of the housing panels and a swing hook attached to the other housing panel.

23. The steering wheel back cover of claim 21, wherein the locking mechanism comprises at least one biased locking finger positioned on each of the upper and lower housing panels, wherein the biased locking fingers are configured to securely engage the opposing housing panel.

24. The steering wheel back cover of claim 23, wherein the alignment mechanism comprises a locking ridge positioned on the upper and lower sidewall panels, wherein the biased locking fingers are configured to securely engage the locking ridge positioned on the opposite housing panel.

25. The steering wheel back cover of claim 23, wherein the alignment mechanism comprises a first arm attached to the upper housing panel and a second arm attached to the lower housing panel, wherein the first and second arms interlock to prevent relative motion of the upper and lower housing panels.

26. The steering wheel back cover of claim 13, wherein housing further comprises a steering wheel mount for securely attaching the housing to a steering wheel.

27. The steering wheel back cover of claim 13, wherein the first and second side joints further comprise gap covers.

28. The steering wheel back cover of claim 13, wherein the first and second side joints further comprise accessory openings.

29. The steering wheel back cover of claim 13, wherein the housing further comprises spoke notches.

30. A steering wheel back cover comprising:
a substantially cylindrical housing having sidewalls and a base, the housing being formed of a first sidewall panel and a second sidewall panel configured to be securely attached to each other at first and second side joints;
a locking mechanism for securing the first and second sidewall panels to each other, the locking mechanism comprising a biased latch including a biased tab affixed to a first sidewall panel and a locking groove formed in a second sidewall panel for receiving the biased tab;
an alignment mechanism for assuring that the first and second sidewall panels are aligned; and
a steering wheel mount for attaching the steering wheel back cover to a steering wheel assembly.

31. The steering wheel back cover of claim 30, wherein the locking groove does not completely perforate the second sidewall panel.

32. The steering wheel back cover of claim 30, wherein the locking mechanism is positioned on the base of the housing.

33. The steering wheel back cover of claim 30, wherein the alignment mechanism comprises a fixed loop attached to a first sidewall panel and a hook attached to a second sidewall panel, wherein the hook is configured to pivot about the fixed loop to align the first and second sidewall panels for attachment.

34. A steering wheel back cover comprising:
a substantially cylindrical housing having sidewalls and a base, the housing being formed of a first sidewall panel and a second sidewall panel configured to be securely attached to each other at first and second side joints;
a locking mechanism for securing the first and second sidewall panels to each other, the locking mechanism comprising at least one locking finger positioned on each of the first and second sidewall panels and a locking ridge positioned on each sidewall panel, wherein the locking fingers are configured such that when aligned for attachment, the teeth on each sidewall panel lock over the locking ridge;
an alignment mechanism for assuring that the first and second sidewall panels are aligned; and
a steering wheel mount for attaching the steering wheel back cover to a steering wheel assembly.

35. The steering wheel back cover of claim 34, wherein the first and second side joints comprise accessory openings.

36. The steering wheel back cover of claim 34, wherein the housing further comprises spoke notches.
